(19) United States
(12) Patent Application Publication
(10) Pub. No.: US 2026/0331904 A1
(43) Pub. Date: Oct. 22, 2026

(54) COMBINED EARTHING AND PROTECTIVE DEVICE FOR A VOLTAGE AND POWER CONVERTER OF MODULAR DESIGN

(71) Applicant: Maschinenfabrik Reinhausen GmbH, Regensburg (DE)

(72) Inventors: Christian Hammer, Regensburg (DE); Josef Wittmann, Saal an der Donau (DE); Axel Brandt, Hennigsdorf (DE); Sebastian Brüske, Kiel (DE)

(21) Appl. No.: 19/112,275

(22) PCT Filed: Sep. 13, 2023
(86) PCT No.: PCT/EP2023/075065

§ 371 Date: Mar. 17, 2025

(30) Foreign Application Priority Data
Oct. 5, 2022 (DE) 10 2022 125 675.8

(51) Int. Cl. H02H 7/125; H01C 7/12; H02M 1/00; H02M 1/32; H02M 7/00

(52) U.S. Cl. CPC H02H 7/1252; H02M 1/007; H02M 1/325; H02M 7/003; H01C 7/12

(57) ABSTRACT

A combined grounding and protective device for a transformer for transforming a primary AC voltage having one or more phases into a secondary voltage. The transformer includes, for each phase of the primary AC voltage, modules to be connected in series. Each module has a voltage input and output for receiving a phase of the primary AC voltage. The device includes input and output contacts that can be conductively connected to the voltage input and output of the module, and each input and output contact connected to the voltage input and output of the same module are connected by a varistor. The varistor is configured to connect the input contact to the output contact when the voltage dropping across the varistor exceeds a first threshold value. A non-conductive switching strip includes a plurality of bridge contacts and is configured to move from an operating position to a grounding position.

### CROSS REFERENCE TO RELATED APPLICATIONS

This application is a U.S. National Phase application under 35 U.S.C. § 371 of International Application No. PCT/EP2023/075065, filed on Sep. 13, 2023, and claims benefit to German Patent Application No. DE 10 2022 125 675.8, filed on Oct. 5, 2022. The International Application was published in German on Apr. 11, 2024 as WO 2024/074270 A1 under PCT Article 21(2).

### FIELD

The present invention relates to a combined grounding and protective device for a voltage and power transformer of modular design for transforming a primary AC voltage having one or more phases into a secondary voltage.

### BACKGROUND

Voltage and power transformers of modular design in the form of solid-state transformers (SST), also referred to as power electronic transformers, are intended to replace the function of conventional 50 Hz oil or cast resin transformers in specific applications, for example in order to convert a high three-phase voltage into a DC voltage. The power electronic transformers are constructed from a large number of single converters for this purpose, wherein, for each phase of the high voltage, a plurality of single converters are connected in series and the single converters connected in series are in turn connected in parallel overall.

The single converters, also referred to as cells, are at a high voltage potential during normal operation and are therefore not accessible to individuals. If maintenance or other work on the SST still needs to be carried out, various safety rules must be observed. In particular, it may be necessary to determine the absence of voltage and to allocate a grounding kit for each of the cells so that each cell is grounded. Due to the large number of individual cells included in an SST, the preparatory work before maintenance is therefore very laborious and time-consuming.

In addition, it may be problematic if an individual cell can no longer carry current due to a fault in the cell since in this case the conductor-conductor voltage of the high voltage, for example 20 kV, drops across the separation point, which may lead, for example, to an explosive destruction of the cell. The remains of the explosively destroyed cell may also destroy additional cells that are arranged adjacent to it, and so the damage is not limited to an individual cell.

### SUMMARY

In an embodiment, the present disclosure provides a combined grounding and protective device for a voltage and power transformer of modular design for transforming a primary AC voltage having one or more phases into a secondary voltage. The voltage and power transformer includes, for each phase of the primary AC voltage, a plurality of individual modules to be connected in series. Each individual module has a respective voltage input and a respective voltage output for receiving a respective phase of the primary AC voltage. The combined grounding and protective device includes a plurality of input contacts and a plurality of output contacts configured in such a way that each input contact can be conductively connected to the respective voltage input of a respective individual module of the plurality of individual modules of the voltage and power transformer and each output contact can be conductively connected to the respective voltage output of the respective individual module of the plurality of individual modules of the voltage and power transformer, and each input contact and each output contact connected to the respective voltage input and the respective voltage output of the same individual module are connected by a varistor. The varistor is configured to conductively connect the input contact to the output contact when the voltage dropping across the varistor exceeds a first threshold value. A non-conductive switching strip includes a plurality of bridge contacts, wherein the switching strip is configured to be moved from an operating position to a grounding position. When the switching strip is in the grounding position, each bridge contact of the plurality of bridge contacts conductively connects the input contact to the output contact, which contacts can be connected to the voltage input and the voltage output of the same individual module, and the input contacts and the output contacts conductively connected by the bridge contacts are connected to a ground connection and, when the switching strip is in the operating position, the input contacts and the output contacts that can be connected to the voltage input and voltage output of the same individual module are not conductively connected by the bridge contacts and the input contacts and output contacts are also not connected to the ground connection.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic construction of an exemplary embodiment of a voltage and power transformer of modular design;

FIG. 2 shows a schematic view of an exemplary embodiment of a voltage and power transformer having a grounding and protective device in an operating position;

FIG. 3 shows a schematic view of the exemplary embodiment of FIG. 2 in a grounding position;

FIG. 4 shows a perspective view of an exemplary embodiment of a voltage and power transformer having an exemplary embodiment of a grounding and protective device in a grounding position;

FIG. 5 shows a second perspective view of the exemplary embodiment of FIG. 4 in which the grounding and protective device is in an operating position;

FIG. 6 shows a sectional view through a part of the exemplary embodiment of a grounding and protective device from FIGS. 4 and 5 in the operating position;

FIG. 7 shows another sectional view through a part of the exemplary embodiment of a grounding and protective device from FIGS. 4-6 in the grounding position;

FIG. 8 shows a perspective view of a part of the exemplary embodiment of a grounding and protective device from FIGS. 4-7 in the operating position;

FIG. 9 shows another perspective view of a part of the exemplary embodiment of a grounding and protective device from FIGS. 4-8 in the grounding position;

FIG. 10 shows a detailed perspective view of another part of the exemplary embodiment from FIGS. 4-10;

FIG. 11 shows a sectional view of another part of the exemplary embodiment from FIGS. 4-10; and

FIG. 12 shows a schematic illustration of an exemplary embodiment of a construction of an individual module of a voltage and power transformer of modular design.

### DETAILED DESCRIPTION

Against this background, a person skilled in the art is tasked with providing a device using which at least some of the problems described above can be solved. Embodiments of the present disclosure can solve these problems by means of a combined grounding and protective device. Embodiments of the present disclosure can provide further refinements of the combined grounding and protective device.

An embodiment of the present disclosure provides a voltage and power transformer of modular design including, for each phase of the primary AC voltage, a plurality of individual modules to be connected in series. Each individual module has a voltage input and a voltage output for receiving a phase of the primary AC voltage.

A first aspect provides a combined grounding and protective device for a voltage and power transformer of modular design for transforming a primary AC voltage having one or more phases into a secondary voltage. The voltage and power transformer includes, for each phase of the primary AC voltage, a plurality of individual modules to be connected in series. Each individual module has a voltage input and a voltage output for receiving a phase of the primary voltage. The combined grounding and protective device includes a plurality of input contacts and a plurality of output contacts configured in such a way that each input contact can be conductively connected to a voltage input of an individual module of the voltage and power transformer and each output contact can be conductively connected to a voltage output of an individual module of the voltage and power transformer. In addition, the input contact and the output contact that can be connected to the voltage input and the voltage output of the same individual module are connected in each case by means of a varistor. The varistor is configured to conductively connect the input contact to the output contact when the voltage dropping across the varistor exceeds a first threshold value. The combined grounding and protective device also includes a non-conductive switching strip having a plurality of bridge contacts. The switching strip is configured to be moved from an operating position to a grounding position. When the switching strip is in the grounding position, a respective bridge contact of the plurality of bridge contacts conductively connects the input contact to the output contact, which contacts can be connected to the voltage input and voltage output of the same individual module. In addition, the input contacts and output contacts that are conductively connected by the bridge contacts are connected to a ground connection. When the switching strip is in the operating position, the input contacts and the output contacts that can be connected to the voltage input and the voltage output of the same individual module are not conductively connected by the bridge contacts, and the input contacts and output contacts are also not connected to the ground connection.

Provision is thus made of a device that takes on three functions at once due to its advantageous design: it connects output and input contacts of individual cells or individual modules of the modular voltage and power transformer, said cells or modules being directly successive in the series circuit, thus connecting the individual modules in series, it protects each of the individual modules from overvoltage by means of the varistors, and it makes it possible, by way of the conductive connection of the input and output contacts when the switching strip is in the grounding position, to connect all individual modules connected in series to a ground connection by moving the switching strip and thus ground same.

In other words, embodiments of the present disclosure can include a plurality of input and output contacts, each of which is provided for contact-connecting corresponding voltage inputs and voltage outputs of individual modules of the combined voltage and power transformer. The number of input contacts and the number of output contacts of the grounding and protective device thus correspond in each case to the number of individual cells. Each pair consisting of an input contact and an output contact is assigned to an individual module and is intended to be connected to the voltage input or the voltage output of the respective individual module.

In one exemplary embodiment, each combined grounding and protective device is provided for grounding and protecting all individual modules of a modular voltage and power transformer that are provided for the transformation of a phase of the primary AC voltage. Therefore, a separate combined grounding and protective device can be provided for each of the phases of the primary AC voltage. For example, in a modular voltage and power transformer to be used for converting a high three-phase voltage into a DC voltage, three groups of individual modules are provided, one group of individual modules for each phase, and three combined grounding and protective devices are also provided accordingly.

In order to protect the individual modules against overvoltage, the input and output contacts assigned in pairs to an individual module are connected to a varistor. The varistors are provided to conductively connect the input and output contacts to one another, that is to say to bridge the individual modules when the voltage dropping across the varistor exceeds a first threshold value. The varistors therefore act in a voltage limiting manner in the event of a defect in an individual module and the associated voltage increase between the voltage input and voltage output of the cell or the assigned input and output contacts.

In addition, the combined grounding and protective device can include a plurality of conductive bridge contacts that are part of a non-conductive switching strip. The switching strip can be moved between two positions, one of which is referred to as the operating position and the other is referred to as the grounding position. For example, the movement of the switching strip between the operating position and the grounding position may be a translational movement in one direction, that is to say the switching strip is translated from the operating position to the grounding position or vice versa.

When the switching strip is in the grounding position, in each case one of the bridge contacts connects an input contact to an output contact, with the interconnected contacts being assigned to the same individual module. The bridge contacts thus establish and short-circuit a conductive connection between the input and output contacts in the grounding position. The number of bridge contacts thus corresponds to the number of individual modules for which the combined grounding and protective devices are intended.

A ground connection can also be provided to ground the short-circuited individual modules, that is to say to connect them to ground. The ground connection can be connected to ground. The combined grounding and protective device is designed such that, in the grounding position, the input and output contacts, which are short-circuited by the bridge contacts, are also connected to the ground connection and thus all individual modules of the combined grounding and protective device are grounded.

However, if the switching strip is moved to the operating position, or if the switching strip is in the operating position, the bridge contacts are moved to a position in which they do not conductively connect the input and output contacts to one another, that is to say they are not short-circuited. There is also no longer a connection between the ground connection and the input and output contacts, and so they are no longer grounded. Thus, embodiments of the present disclosure for a combined grounding and protective device advantageously provide a possibility by which the individual modules can both be protected from an overvoltage and, for example for maintenance, be grounded.

In one preferred embodiment of the grounding and protective device, for the series connection of the individual modules of the voltage and power transformer, the output contact, which can be connected to the voltage output of an individual module to be connected in series beforehand, is conductively connected to the input contact by means of a conductor line, which can be connected to the voltage input of the individual module to be subsequently connected in series. In the preferred embodiment, the grounding and protective device thus advantageously also takes on the series connection of all the individual modules thereof that are provided for receiving the same phase in the voltage and power transformer of modular design.

In other words, the grounding and protective device in the preferred embodiment includes a plurality of conductor lines, which can be formed, for example, by conductive metal rails. The number of conductor lines or busbars is one smaller than the number of individual modules that are to be protected and grounded using the grounding and protective device. Each of the conductor lines connects an output contact of the grounding and protective device to an input contact of the grounding and protective device. In this case, the output contact is conductively connected to the input contact, said contacts being provided to be connected in each case to the voltage output and the voltage input of individual modules to be connected directly in succession in series.

The bridge contacts used for grounding the individual modules can, for example, in the grounding position of the switching strip, connect the two conductor lines to one another conductively, said lines being connected to the input contact and the output contact, which contacts are each provided for connection to the same individual modules. The input and output contacts are therefore short-circuited by the conductive connection of the conductor lines if the voltage and power transformer of modular design is to be grounded. In this case, the conductor lines would also be conductively connected to the ground connection and thus be grounded. For this purpose, for example, provision may be made of an additional conductor line that is adapted to be connected to the voltage output of the last individual module in the series connection and that is electrically connected to the ground connection in the grounding position of the switching strip and is electrically isolated therefrom in the operating position.

In one preferred embodiment, a spark gap is formed between each input contact and each output contact, which contacts can be connected to the voltage input and the voltage output of the same individual module, which spark gap is configured in such a way that a voltage flashover occurs when the voltage drop across the spark gap exceeds a second threshold value, wherein the second threshold value is preferably greater than the first threshold value. If, in the event of an extreme fault, for example in the case of a breakdown of the high-voltage isolation of an individual module, the mains voltage should drop across only a few remaining individual modules and if the varistors provided for the protection of the individual modules should fail, the individual modules will be additionally protected via the spark gaps across which the voltage drops in this case.

The spark gap is preferably formed in each case between a second end of the conductor line, which is connected to the input contact, and a first end of the conductor line, which is connected to the output contact. Therefore, no additional components need to be provided for the spark gaps. Instead, they are advantageously formed through suitable formation and arrangement of the conductor lines that are already provided.

Spring-loaded contact pins are preferably provided for connecting the conductor lines to the bridge contacts. These are preferably held in a common carrier made of a non-conductive material. For example, the spring-loaded contact pins may be biased with respect to the bridge contacts to allow reliable contact-connection of the bridge contacts when they are moved.

It is also preferable when each conductor line includes two contact pins, which are each in contact with the same bridge contact in the operating position of the switching strip and which are each in contact with different bridge contacts in the grounding position of the switching strip. In the preferred embodiment, provision is thus made, in normal operation, for the bridge contacts originating from the same conductor line to bear against or be in contact with the same bridge contact by way of their contact surfaces. The contact pins that are assigned to the same conductor line are thus conductively connected both by the conductor line and by a bridge contact in the operating position of the switching strip. In the grounding position of the switching strip, the contact pins that are assigned to the same conductor line are only conductively connected by the conductor line. On the other hand, they are connected to other conductor lines via the bridge contacts in order to short-circuit and thus ground the individual modules.

An embodiment of the grounding and protective device can preferably include an electric drive that moves the switching strip from the operating position to the grounding position. The electric drive more preferably moves the switching strip via a threaded spindle.

In one preferred embodiment, the ground connection is formed by a ground rail and the switching strip is configured such that a contact blade conductively connected to the bridge contacts engages in the ground rail when the switching strip is moved from the operating position to the grounding position. In other words, an electrical connection to ground is established by a mechanical engagement between a contact blade, which is conductively connected to the switching strip or is part of the switching strip, and a ground rail. This makes it possible to determine whether the individual modules of the voltage and power transformer of modular design are grounded by simply checking visually whether the contact blade is in contact with the ground rail.

The contact blade, in a preferred embodiment, snaps into the ground rail when the switching strip is moved from the operating position to the ground position. This prevents the connection between the contact blade and the ground rail from being able to become loose without external action or operation.

The grounding and protective device, in a preferred embodiment, includes a lever using which the switching strip can be moved manually from the operating position to the grounding position, wherein an operator of the grounding and protective device can preferably identify from a position of the lever whether the switching strip is in the operating position or the grounding position. This enables an operator of the modular voltage and power transformer to identify whether the device is operating or grounded directly from the position of the lever.

A second aspect provides a voltage and power transformer of modular design for transforming a primary AC voltage having one or more phases into a secondary voltage, said transformer having one or more combined grounding and protective devices as claimed in any one of the preceding embodiments. The voltage and power transformer includes, for each phase of the primary AC voltage, a plurality of individual modules connected in series, wherein each individual module has a voltage input and a voltage output for receiving a phase of the primary voltage, wherein each voltage input is conductively connected to an input contact of the grounding and protective device and each voltage output is conductively connected to an output contact of the grounding and protective device.

The advantages of the voltage and power transformer correspond to the advantages of the combined grounding and protective device used therein.

Each individual module, in a preferred embodiment, includes a transformer for voltage and power transformation between an input side of the individual module and an output side of the individual module, and a spark gap, wherein the voltage input and the voltage output of the individual module are arranged on the input side of the individual module and wherein the spark gap is arranged in parallel with the transformer and is configured in such a way that a voltage flashover occurs when the voltage drop across the spark gap exceeds a third threshold value. The spark gap within the individual modules can lead to a controlled destruction of the individual modules in the event of a fault, especially if the varistors and/or the spark gaps of the combined earthing and protective device should not suffice.

Each individual module, in a preferred embodiment, includes a housing designed such that, if an individual module is destroyed due to an overvoltage, individual modules that are arranged adjacent to the destroyed individual module are not damaged. This advantageously limits the damage caused by the destruction of individual modules, and the voltage and power transformer in principle remains ready for operation.

The varistors are, in a preferred embodiment, arranged in such a way that, if an individual module is destroyed due to an overvoltage, there is no damage to the varistor that connects the input contact to the output contact, each of said contacts being connected to the voltage input and the voltage output of the destroyed individual module. This can be ensured in particular by the fact that the varistor can take over the branch current until its decay and at the same time contributes to the countervoltage of the line with its varistor voltage instead of the cell. This enables the voltage and power transformer to continue to operate, since the varistor bypasses the destroyed individual module and is not damaged itself.

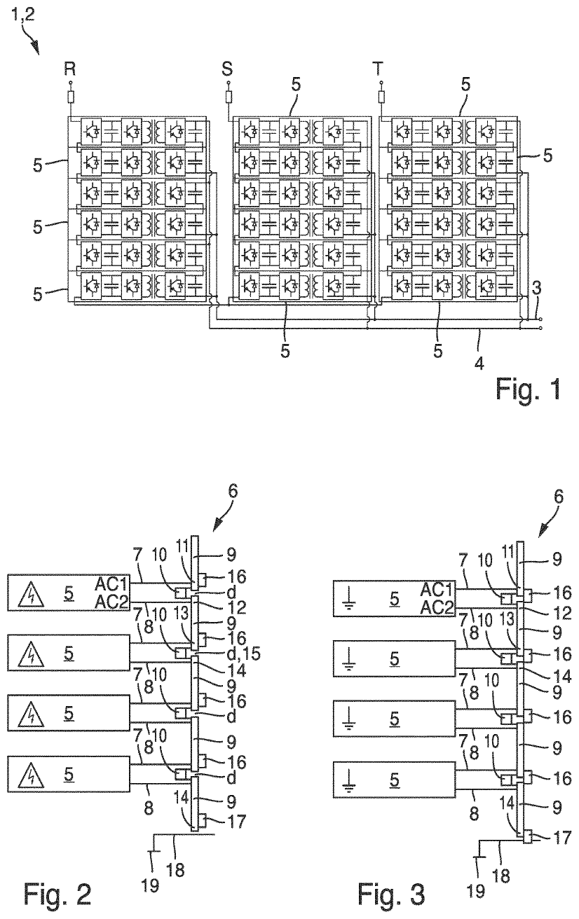

FIG. 1 shows an exemplary embodiment of a voltage and power transformer 1 of modular design, using which a high three-phase voltage is converted into a DC voltage. FIG. 1 shows a solid-state transformer 2, which is also referred to as a power electronic transformer, as an example of a voltage and power transformer 1 of modular design. The high voltage may be, for example, a three-phase AC voltage with a voltage of 20 kV, while the DC voltage is +/−750 V.

The voltage and power transformer 1 has, for each phase of the high three-phase voltage, a phase conductor R, S, T and two output conductors 3, 4 for the DC voltage. For example, the first output conductor 3 is at a voltage of −750 V, while the second output conductor 4 is correspondingly at a voltage of +750 V.

The voltage and power transformer 1 has six individual modules 5 connected in series for each phase of the primary AC voltage. The voltage and power transformer shown in FIG. 1 thus has a total of 18 individual modules. Since the individual modules 5, which can also be referred to as cells or individual cells, are connected in series, only a portion of the high voltage drops across each individual module. In FIG. 1, only a few of the individual modules 5 are provided with reference numerals so that the figure remains readable overall. Each individual module 5 includes power electronics used to convert a portion of a phase of the high voltage into a DC voltage. The construction of the (identical) individual modules 5 is explained in more detail elsewhere with reference to FIG. 12.

FIGS. 2 and 3 disclose an exemplary embodiment of a combined grounding and protective device 6 for a voltage and power transformer 1 of modular design, as shown, for example, in FIG. 1. FIG. 2 shows the combined grounding and protective device 6 in an operating position and FIG. 3 shows the grounding and protective device 6 in a grounding position.

FIGS. 2 and 3 show four individual modules 5 of the voltage and power transformer 1 of modular design, these individual modules being used for the transformation of a phase of the primary voltage. Each individual module 5 has a voltage input 7 and a voltage output 8. In order to connect the individual modules 5 in series, a voltage output 8 of an individual module 5 to be connected in series is conductively connected to a voltage input 7 of the subsequent individual module 5 to be connected in series. For this purpose, the combined grounding and protective device 6 includes a plurality of conductor lines 9. Each conductor line 9 connects the voltage output 8 of an individual module 5 to the voltage input 7 of the subsequent individual module 5.

The conductor lines 9 thus represent, on the one hand, input contacts 11, using which the conductor lines 9 are each directly conductively connected to the voltage inputs 7 of the individual modules 5. On the other hand, the conductor lines 9 also form output contacts 12, at which the conductor lines 9 are directly conductively connected to the voltage outputs 8 of the individual modules 5. The input and output contacts 11, 12 may, for example, be in direct physical contact with the voltage inputs 7 or voltage outputs 8. In order not to overload the illustration in FIGS. 2 and 3, in each case only one input contact 11 and one output contact 12 are provided with a reference sign.

The conductor line 9 directly conductively connected to the voltage input 7 of an individual module 5 and the conductor line 9 directly conductively connected to the voltage output 8 of the same individual module 5 are each connected via a varistor 10. The varistors 10 are configured so that they conductively connect the directly consecutive conductor lines 9 to one another when the voltage drop between the input contact 11 and the output contact 12, which contacts are assigned to the same individual module 5 or which are directly connected to the voltage input 7 and the voltage output 8 of the same individual module 5, exceeds a first limit value or threshold value.

If there is a defect in an individual module 5, in which the current flow within the individual module 5 or between the conductor lines 9 and the individual module 5 is interrupted, the conductor-conductor voltage of the high-voltage network, that is to say for example 20 kV, would drop directly across the isolating point, causing corresponding destruction. In particular, the individual module 5 may be completely destroyed, which in turn results in the destruction of further individual modules 5 and thus, as a result, of the entire voltage and power transformer 1 of modular design. Varistors 10 that limit the maximum voltage drop across the individual modules 5 to the first threshold value are provided as a protective measure in this case.

A distance d between a second end 13 of a conductor line 9 directly conductively connected to the voltage input 7 of an individual module 5 and a first end 14 of the conductor line 9 directly conductively connected to the voltage output 8 of the same individual module 5 has been selected so that a spark gap 15 is formed between the first end 14 and the second end 13 of the conductor lines. Due to the selection of the distance d, there is a voltage flashover across the spark gap 15 when the voltage drop across the spark gap 15 exceeds a second threshold value. The second threshold value is greater than the first threshold value upon exceeding of which the varistors 10 connect the input and output contacts 11, 12 of two directly consecutive conductor lines 9 to one another.

The spark gap 15 thus serves as additional safety measure if, in an extreme fault case, for example a breakdown of the high-voltage isolation of an individual module 5, the high voltage of, for example, 20 KV drops across only a few remaining individual modules 5 and in addition one of the varistors 10 fails. In this case, the short-circuit current is taken on by the spark gap 15 formed between two conductor lines 9. This will prevent further damage or limit the occurrence of damage. In FIGS. 2 and 3, only one of the spark gaps 15 is provided with a reference sign in order not to overload the drawing with reference signs.

Finally, the combined grounding and protective device also includes a non-conductive switching strip having a plurality of bridge contacts 16. The switching strip is not illustrated in FIGS. 2 and 3, but is described in more detail below with reference to further exemplary embodiments.

The number of bridge contacts 16 corresponds to the number of individual modules 5 for which the combined grounding and protective device 6 is provided in FIGS. 2 and 3, that is to say a bridge contact 16 is provided for and also assigned to each individual module 5. The switching strip, not illustrated in FIGS. 2 and 3, can be moved back and forth between an operating position and a grounding position. The bridge contacts 16 are arranged on the switching strip in such a way that they move with this between the operating position and the grounding position back and forth.

In this case, the bridge contacts 16 are arranged on the switching strip in particular in such a way that each bridge contact 16 conductively connects the input contact 11 to the output contact 12, which contacts are assigned to the same individual module 5 when the switching strip is in the grounding position. In other words, the bridge contacts 16 in the grounding position of the switching strip short-circuit the input contacts 11 and the output contacts 12 respectively, which contacts are provided for connection to the same individual module 5. If the switching strip is in the operating position, the input contacts 11 and the output contacts 12, which are assigned to the same individual module 5, are not connected by the bridge contacts 16. The input and output contacts 11, 12 are therefore not short-circuited.

Finally, the combined grounding and protective device shown in FIGS. 2 and 3 still has a grounding element 17, via which the short-circuited input and output contacts 11, 12 can be connected to a ground connection 18. In the exemplary embodiment in FIGS. 2 and 3, the grounding element 17 as well as the bridge contacts 16 are fixed to the switch strip, not illustrated, and moved back and forth together with the switch strip between an operating position and a grounding position.

FIG. 3 shows the grounding and protective device 6 in a grounding state in which the switching strip, not illustrated, is in the grounding position. In this position, the grounding element 17 connects the conductor line 9, the first end 14 of which is connected to the voltage output 8 of the last series-connected individual module 5, to the ground connection 18. All conductor lines 9 are conductively connected to one another or short-circuited via the bridge contacts 16. Therefore, all conductor lines 9 and thus also the individual modules 5 are connected to the ground connection 18 and thus to ground 19. The individual modules 5 connected to the combined grounding and protective device 6 are therefore de-energized in the grounding state thereof.

The operating state of the grounding and protective device 6 is illustrated in FIG. 2. In this figure, the switching strip is in the operating position so that the individual conductor lines 9 are no longer connected by the bridge contacts 16 and also no connection between the last conductor line 9 and the ground connection 18 is established by the grounding element 17. The individual modules 5 to be protected by the grounding and protective device 6 are therefore ready for operation and can transform the applied phase of a high voltage into a DC voltage.

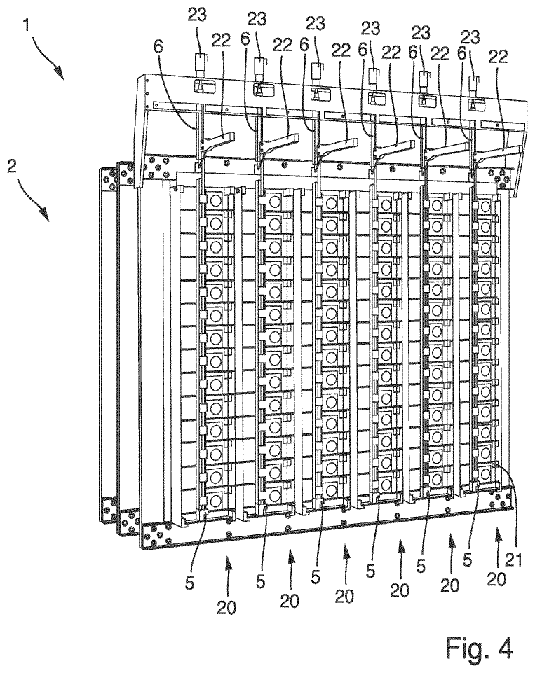

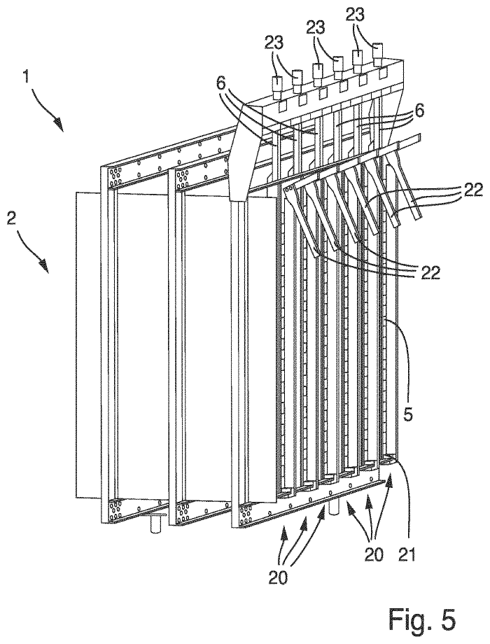

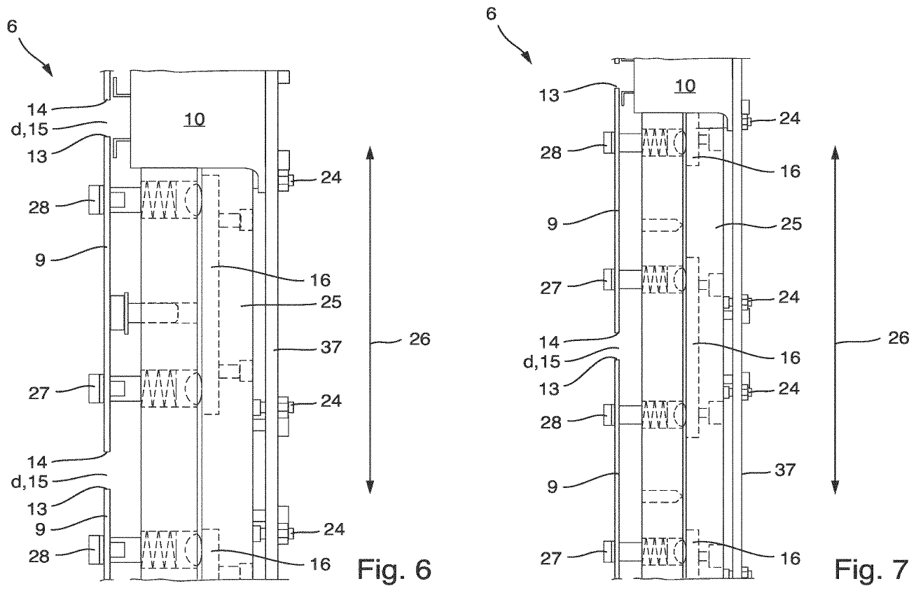

The following text describes with reference to FIGS. 4 to 11 an exemplary embodiment of a voltage and power transformer 1 of modular design having six exemplary embodiments of combined grounding and protective devices 6. FIGS. 4 and 5 show external perspective views of the voltage and power transformer 1 of modular design, while FIGS. 6-11 show various details of the voltage and power transformer 1 and the combined grounding and protective devices 6, respectively.

The voltage and power transformer 1 shown in FIGS. 4 and 5 is again a solid-state transformer (SST) 2, which is provided for transforming a three-phase 20 kV input AC voltage into a +/−750 V DC voltage. In FIG. 4, the voltage and power transformer 1 is grounded by means of the combined grounding and protective devices 6, while the transformer 1 in FIG. 5 is ready for operation.

The transformer 1 has 28 individual modules 5 connected in series for the transformation of each phase of the input AC voltage or high voltage. Of the individual modules 5 in FIGS. 4 and 5, in each case only individual ones are characterized by reference signs so as not to impair readability. The individual modules 5 are arranged in the modular transformer 1 in each case in stacks or columns 20, wherein in each case the individual modules 5 of two columns 20 are connected in series in order to transform one of the three phases of the input AC voltage into a direct current or a DC voltage.

In FIG. 5, it can also be seen that each individual module 5 is arranged in a separate housing 21. The housings 21 are made of metal, for example, and are designed so that, in the event of an explosive destruction of the components of an individual module 5 due to an overvoltage, the adjacent individual modules 5 are not or at least only slightly damaged.

The modular voltage and power transformer 1 has a separate combined grounding and protective device 6 for each column or each stack 20 of individual modules 5. Therefore not only precisely one combined grounding and protective device 6, but two combined grounding and protective devices 6 are provided for each phase of the high voltage. The details of the grounding and protective devices 6 are explained in more detail below with reference to FIGS. 6-11. However, it should be noted at this point that each of the grounding and protective devices 6 has a lever 22, the position of which indicates whether the respective grounding and protective device 6 or the individual modules 5 connected thereto are in operation (as in FIG. 5) or are grounded (as in FIG. 4).

To switch between the operating position and the grounding position or the corresponding state, a user can manually move the lever 22 of the respective grounding and protective devices 6 back and forth, said lever being connected to a switching strip. As an alternative, a switchover can also take place automatically via electric actuators 23 in the form of spindle drives 23, which also move the switching strip and thus also the levers 22. Only a few of the spindle drives 23 are provided with reference signs so as not to overload the drawing. From the position of the lever 22, a user or operator of the device can advantageously see immediately whether or not the transformer 1 is de-energized, that is to say grounded.

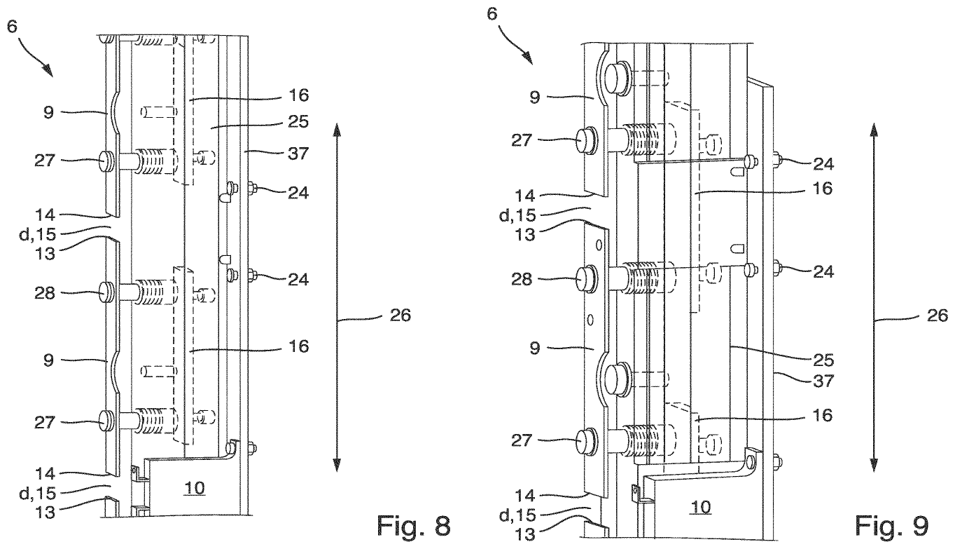

FIGS. 6 to 9 show a section of the exemplary embodiment of a combined grounding and protective device 6 from FIGS. 4 and 5. FIGS. 6 and 7 show cuts through a section of the grounding and protective device 6, and FIGS. 8 and 9 show perspective views in which some elements of the device 6 are illustrated transparently. FIGS. 6 and 8 illustrate the grounding and protective device 6 in the operating position and FIGS. 7 and 9 illustrate the grounding and protective devices 6 in the grounding position. For the sake of completeness, it should be noted that FIGS. 6-9 show slightly different sections of the combined grounding and protective device 6.

The exemplary embodiment of a combined grounding and protective device 6 first includes a carrier rail 37 on which multiple varistors 10 are arranged. FIGS. 6-9 each show only one varistor 10. In total, the combined grounding and protective device 6 includes 14 varistors, one for each individual module 5 to be protected by the device 6. In the sections illustrated, another varistor is arranged, as can be seen at the respective fixing means 24 shown. However, the illustration of these varistors was not included in order not to obscure the underlying configuration of the grounding and protective device 6.

As already explained with reference to FIGS. 2 and 3, the varistors 10 are provided to be conductively connected to the voltage input 7 and the voltage output 8 of an individual module 5. The varistors 10 are configured to conductively connect the voltage input 7 to the voltage output 8 of the respective individual module 5 when the voltage drop across the varistor 10 exceeds a first threshold value. Thus, the varistors 10 prevent the destruction of the individual modules 5 in the event of an overvoltage higher than the first threshold value.

The grounding and protective device 6 further includes a plurality of conductor lines 9, which are each provided for connecting the voltage output 8 of a preceding individual module 5 in the series connection of the individual modules 5 to the voltage input 7 of the subsequent individual module 5 in the series connection of the individual modules 5. The input and output contacts 11, 12 of the device 6 that establish the contact between the conductor lines 9 and the voltage inputs and outputs 7, 8.

In addition, the grounding and protective device 6 includes a plurality of bridge contacts 16, which are arranged on a non-conductive switching strip 25. The bridge contacts 16 are arranged on the switching strip 25 so that they move with the switching strip 25 along an adjustment direction 26, in which the switching strip 25 is moved between a grounding position (shown in FIGS. 7 and 9) and an operating position (shown in FIGS. 6 and 8).

If the switching strip 25 is in the operating position, each bridge contact 16 is connected to only one of the conductor lines 9 via two spring-loaded contact pins 27, 28. Thus, the bridge contacts 16 in the operating position form a parallel current path to the conductor lines 9 and thus contribute to the series connection of the individual modules 5.

If, on the other hand, the switching strip 25 is arranged in the grounding position, as is illustrated in FIGS. 7 and 9, each of the bridge contacts 16 connects a spring-loaded contact pin 27 of a preceding conductor line 9 in the series circuit of the individual modules 5 to a spring-loaded contact pin 28 of a subsequent conductor line 9 in the series circuit of the individual modules 9. Therefore, the conductor lines 9 and thus the individual modules are short-circuited, the voltage inputs or outputs of said modules are each connected to two conductor lines 9 which are conductively connected by a bridge contact 16, and the individual modules 5 are de-energized when the bridge contacts 16 are connected simultaneously with ground.

Finally, a spark gap 15, which is configured so that the voltage from the second end 14 of a preceding conductor line 9 in the series circuit flashes over to the first end 13 of a subsequent conductor line 9 in the series circuit, is formed between the first and second ends 13, 14 of the conductor lines 9 when the voltage between the ends 13, 14 exceeds a second threshold value that is greater than the first threshold value. The second threshold value can be set by the distance d between the first end 13 and the second end 14. The spark gaps 15 are thus arranged parallel to the varistors 10 and protect the individual modules 5 from damage due to overvoltages in case the varistors 10 should fail.

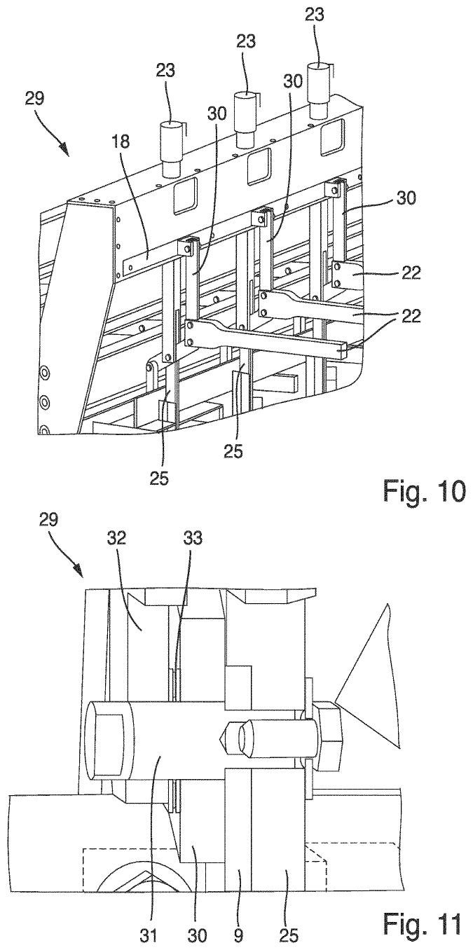

FIG. 10 shows the construction of the lever assembly 29 in more detail, the switching strips 25 being able to be moved back and forth between the operating position and the grounding position via said lever assembly. The switching strips 25 are normally moved by the actuator motors 23, which are supplied via an external power source (not illustrated). The actuator motors 23 have a non-self-locking threaded spindle and have a brake. If the motors fail, the switching strips 25 can be moved manually by means of the levers 22.

The movement of the switching strips 25 also moves a contact blade 30, which connects the conductor lines 9 to a ground connection 18. The contact blade 30 engages with the ground connection 18 so that additional force is required to move the contact blade 30 back out of engagement with the ground connection 18.

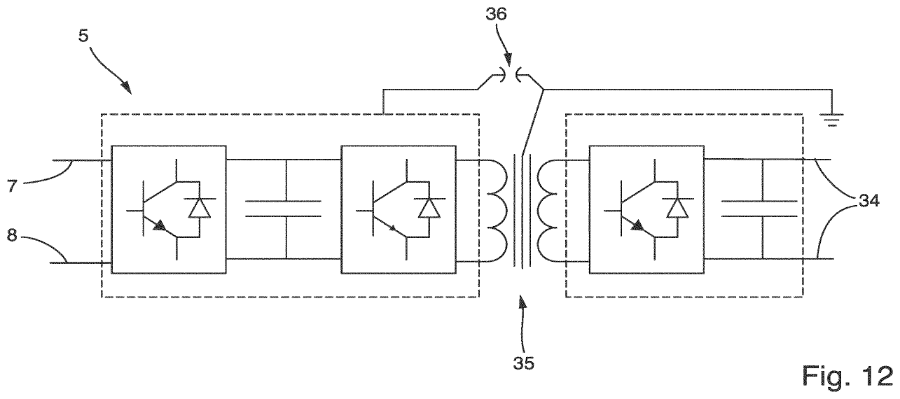

FIG. 11 shows a further detail of the construction of the lever assembly 29. In particular, a pin 31 that connects the contact blade 30, (extended) conductor line 9, switching strip 25 and an actuating element 32 is shown. The actuator motor 23 can change the position of the switching strip 25 via the actuating element 32. The contact blade 30 and the extended conductor line 9 are conductively connected to one another, while a disk spring 33 prevents conductive contact between the contact blade 30 and the actuating element 32. The pin 31 is also of non-conductive design.

Finally, FIG. 12 shows an equivalent circuit diagram for an individual module 5. The individual module 5 includes a voltage input 7 and a voltage output 8, via which the high voltage to be transformed is received. In addition, the individual module 5 has two DC voltage outputs 34. The central element of the individual module is a small-format transformer 35, which may advantageously be a medium-frequency transformer with a frequency of 10 kHz to 100 kHz, since this enables a small-format configuration in a simple manner. Should this transformer 35 fail due to an overvoltage, an additional spark gap 36 is also provided. The spark gap 36 in the interior of the individual modules 5 is designed so that a voltage flashover occurs when a third threshold value is exceeded, wherein the third threshold value is greater than the second threshold value. The spark gap 36 prevents or limits the destruction of the individual modules 5 in extreme fault cases, in which the total high voltage essentially drops across the individual module 5.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1 Modular voltage and power transformer
2 Solid-state transformer, power electronic transformer
R, S, T Phase conductor
3,4 DC output conductor
5 Individual modules, individual cell, cell
6 Combined grounding and protective device
7 Voltage input
8 Voltage output
9 Conductor line
10 Varistor
11 Input contact
12 Output contact
13 Second end of a conductor line 9
14 First end of a conductor line 9
15 Spark gap
D Distance between the second end of a conductor line 9 and the first end of a subsequent conductor line 9
16 Bridge contact
17 Grounding element
18 Ground connection
19 Ground
20 Column or stack of individual modules
21 Housing of an individual module
22 Lever
23 Actuator, spindle motor
24 Fixing means
25 Switching strip
26 Adjustment direction
27 Contact pin
28 Contact pin
29 Lever assembly
30 Contact blade
31 Pin
32 Actuating element
33 Disk spring
34 DC outputs
35 Transformer
36 Spark gap
37 Carrier rail

1: A combined grounding and protective device for a voltage and power transformer of modular design for transforming a primary AC voltage having one or more phases into a secondary voltage, wherein the voltage and power transformer comprises, for each phase of the primary AC voltage, a plurality of individual modules to be connected in series, wherein each individual module has a respective voltage input and a respective voltage output for receiving a respective phase of the primary AC voltage, wherein the combined grounding and protective device comprises:
a plurality of input contacts and a plurality of output contacts configured in such a way that each input contact can be conductively connected to the respective voltage input of a respective individual module of the plurality of individual modules of the voltage and power transformer and each output contact can be conductively connected to the respective voltage output of the respective individual module of the plurality of individual modules of the voltage and power transformer, and each input contact and each output contact connected to the respective voltage input and the respective voltage output of the same individual module are connected by a varistor, wherein the varistor is configured to conductively connect the input contact to the output contact when the voltage dropping across the varistor exceeds a first threshold value, and
a non-conductive switching strip comprising a plurality of bridge contacts, wherein the switching strip is configured to be moved from an operating position to a grounding position, wherein, when the switching strip is in the grounding position, each bridge contact of the plurality of bridge contacts conductively connects the input contact to the output contact, which contacts can be connected to the voltage input and the voltage output of the same individual module, and the input contacts and the output contacts conductively connected by the bridge contacts are connected to a ground connection and wherein, when the switching strip is in the operating position, the input contacts and the output contacts that can be connected to the voltage input and voltage output of the same individual module are not conductively connected by the bridge contacts and the input contacts and output contacts are also not connected to the ground connection.

2: The grounding and protective device as claimed in claim 1, wherein, for a series connection of the individual modules of the voltage and power transformer, the output contact, which can be connected to the voltage output of an individual module to be connected in series beforehand, is conductively connected by means of a conductor line to the input contact, which can be connected to the voltage input of the individual module to be subsequently connected in series.

3: The grounding and protective device as claimed in claim 1, wherein a spark gap is formed between each input contact and each output contact, which contacts can be connected to the voltage input and the voltage output of the same individual module, which spark gap is configured in such a way that a voltage flashover occurs when the voltage drop across the spark gap exceeds a second threshold value, wherein the second threshold value is greater than the first threshold value.

4: The grounding and protective device as claimed in claims 2, wherein the spark gap is formed in each case between a second end of the conductor line, which is connected to the input contact, and a first end of the conductor line, which is connected to the output contact.

5: The grounding and protective device as claimed in claim 1, wherein spring-loaded contact pins, which are mounted in a common carrier made of a non-conductive material, are provided for connecting the conductor lines to the bridge contacts.

6: The grounding and protective device as claimed in claim 5, wherein each conductor line comprises two contact pins, which contact pins are each in contact with the same bridge contact in the operating position of the switching strip and which are each in contact with different bridge contacts in the grounding position of the switching strip.

7: The grounding and protective device as claimed in claim 1, wherein the grounding and protective device further comprises an electric drive, which moves the switching strip from the operating position to the grounding position, wherein the electric drive moves the switching strip via a threaded spindle.

8: The grounding and protective device as claimed in claim 1, wherein the ground connection is formed by a ground rail and wherein the switching strip is configured such that a contact blade conductively connected to the bridge contacts engages in the ground rail when the switching strip is moved from the operating position to the grounding position.

9: The grounding and protective device as claimed in claim 8, wherein the contact blade latches to the ground rail when the switching strip is moved from the operating position to the grounding position.

10: The grounding and protective device as claimed in claim 9, wherein the grounding and protective device further comprises a lever, using which the switching strip is moved manually from the operating position to the grounding position, wherein an operator of the grounding and protective device identifies from a position of the lever whether the switching strip is in the operating position or the grounding position.

11: A voltage and power transformer of modular design for transforming a primary AC voltage having one or more phases into a secondary voltage, the transformer comprising one or more combined grounding and protective devices as claimed in claim 1.
wherein the voltage and power transformer comprises, for each phase of the primary AC voltage, a plurality of individual modules connected in series, wherein each individual module has a voltage input and a voltage output for receiving a phase of the primary voltage, wherein each voltage input is conductively connected to an input contact of the grounding and protective device and each voltage output is conductively connected to an output contact of the grounding and protective device.

12: The voltage and power transformer as claimed in claim 11, wherein each individual module comprises a transformer for voltage and power transformation between an input side of the individual module and an output side of the same individual module, and a spark gap,
wherein the voltage input and the voltage output of the same individual module are arranged on the input side of the same individual module and
wherein the spark gap is arranged in parallel with the transformer and is configured in such a way that a voltage flashover occurs when the voltage drop across the spark gap exceeds a third threshold value.

13: The voltage and power transformer as claimed in claim 11, wherein each individual module comprises a housing designed such that, when an individual module of the plurality of individual modules is destroyed due to an overvoltage, individual modules that are arranged adjacent to the destroyed individual module are not damaged.

14: The voltage and power transformer as claimed in claim 11, wherein the varistors are arranged in such a way that, when an individual module of the individual modules is destroyed due to an overvoltage, there is no damage to the varistor that connects the input contact to the output contact, each of the inputs contacts being connected to the voltage input and the output contacts being connected to the voltage output of the destroyed individual module.
